(19) United States
(12) Patent Application Publication
(10) Pub. No.: US 2010/0227100 A1
(43) Pub. Date: Sep. 9, 2010

(54) Images on window blinds and shades

(76) Inventor: Timothy Mark Weeks, Richmond, VA (US)

Correspondence Address: Timothy Mark Weeks, 4819 W Franklin St, Richmond, VA, 23226, US

(21) Appl. No.: 12/428,278

(22) Filed: Sep. 9, 2009

Related U.S. Application Data
(60) Provisional application No. 61/125,091, filed on Apr. 22, 2008.

(51) Int. Cl. C09J 7/02; B32B 3/10

(52) U.S. Cl. 428/40.1; 428/195.1

(57) ABSTRACT

The present invention relates to a decorative coatings and a method for modifying or altering existing horizontal or vertical blinds, louvers and the like. The decorative coating or adhesive layer is designed to conform to any preexisting vertical or horizontal louver assembly. In a preferred embodiment, the images on window blinds and shades device of the present invention comprises a transparent coating which is designed to adhere to a slat of an existing vertical blind assembly, thereby creating a two sided image. On either one or both sides of the slat a decorative adhesive layer is positioned. The decorative layer may be any design that provides the desired decorative intent, such as logos, trade marks, team names and the like. The images on window blinds and shades can be easily and quickly installed onto any existing solid surface louver assembly without the use of any special tools or exceptional skills. The decorative layer, in the form of a partial strip or section of a larger image or design, is simply positioned onto the slat and in order of the design layout. When the images on window blinds and shades is installed onto each of the slats of the existing blind assembly, an integrated or complete image, design or the like is created when the thus-covered slats are viewed in their entirety. In an alternative embodiment, the universal covering case is in the form of an installation kit containing a plurality of pre-selected, pre-positioned decorative inserts.

### FIELD OF THE INVENTION

The present invention relates to a universal covering and method for modifying or altering any existing vertical or horizontal blind assembly. The Images on window blinds and shades comprises a decorative coating which is designed to individually decorate a slat of an existing blind assembly and further accommodates adjoining designs, thereby creating a multiple-layer effect, hereinafter sometimes referred to as the “louver”. The images on window blinds and shades can be easily and quickly installed onto any existing solid surface louver assembly.

### BACKGROUND OF THE INVENTION

Vertical and horizontal blind assemblies, such as color-coordinated or fabric-covered vertical blinds, mini-blinds, Roman blinds and the like, are well known as means of covering window and doors. Such blind assemblies not only offer the consumer privacy when said blind assemblies are in the closed position, but also provide the consumer with a means for enhancing the decor of a room. However, when the consumer desires logos or team decorations for their style, color or design the consumer is either hindered or restricted in the manner in which the decor can be modified or created.

Various attempts have been made in the prior art to provide means for decorating blinds, louvers and the like, such as the vertical louver assemblies installed over windows, sliding glass doors, and the like. For example, louver systems have been offered wherein the louver comprises slots or flanges, typically along the longitudinal edges of the louver, in order to accommodate a decorative material, such as wall paper, textile materials etc., as disclosed in U.S. Pat. Nos. 4,049,038, 4,434,834, 4,519,435, and 5,141,042.

Another known approach to decorating louvers has been the use of tubes or envelopes in which a fabric material can be slipped over existing louvers to provide decorative covers. Such fabric covers are disclosed in U.S. Pat. Nos. 5,101,876 to Zak and 4,911,220 to Hiller. These fabric covers address some of the aforementioned problems associated with purchasing and installing new louvers and fixtures. However, their appeal is limited insofar as the use of a homogenous fabric is required, thereby limiting the potential artistic design that can be created to a single color or a muted pattern. Further, installation may be time-consuming and changing the fabric material requires disassembling the entire louver system.

No solution of modifying or altering existing blind assemblies has been offered which utilizes the a decorative coating which can create an unlimited array of design for both sides of the louvers including logos, team names, trade names and advertisements.

### SUMMARY OF THE INVENTION

The present invention offers a line of window coverings that will enhance a room. This innovative product line features a variety of printed images on one or both sides of blinds. When blinds are closed, the complete image will appear. Preprinted images may include maps, professional, collegiate, and high school sports team logos, Nascar or other racing team, company or advertising logos, and other easy to distinguish pictures, symbols, or designs. A consumer may also upload personal photos for custom creations allowing the display of a cherished child or beloved pet on a usable window or door blind. Images may be adhered, drawn, airbrushed painted, or LED/LCD onto vertical or horizontal blinds, Venetian or roller shades. Adhesive strips are made to fit onto the slats that present the images to ensure a complete and easy to view image, when blinds are closed. Exact measurements, images, and colors may vary.

Many home and business owners cover windows with a standard type of window blind or shade. While blinds may provide a suitable covering for a window, they often lack aesthetic appeal. Colors may vary, but even colors that match or compliment room décor can prove boring and lifeless. Improvement: Image on Blinds is a specially made line of blinds that will provide a fun and exciting approach to decorating. The blinds feature images, designs, and prints suitable for enjoyment in a living room, bedroom, kitchen, and any other room in need of window coverings. Windows in a home, apartment, office, dorm, and even on a boat are ideal for the decorative coverage that Image on Blinds provides.

Decorative Images on Window Blinds or Shades.

It is an object of the present invention to provide a universal covering coating and method for modifying or altering the appearance of any solid surface louvered window blind.

It is a further object of the present invention to provide images on window blinds and shades which can be installed onto an existing horizontal or vertical blind assembly without the use of tools or special skills.

It is another object of the present invention to provide images on window blinds and shades which utilizes the structural components of an existing horizontal or vertical blind assembly, including the track system, and does not require the modification or elimination of any elements or fixtures thereof.

It is still another object of the present invention to provide images on window blinds and shades and method which is designed to easily accommodate a decorative coating in order to change or modify the decor of a room or the outside appearance of a window or door expanse.

### BRIEF DESCRIPTION OF THE DRAWING

### Drawing Views

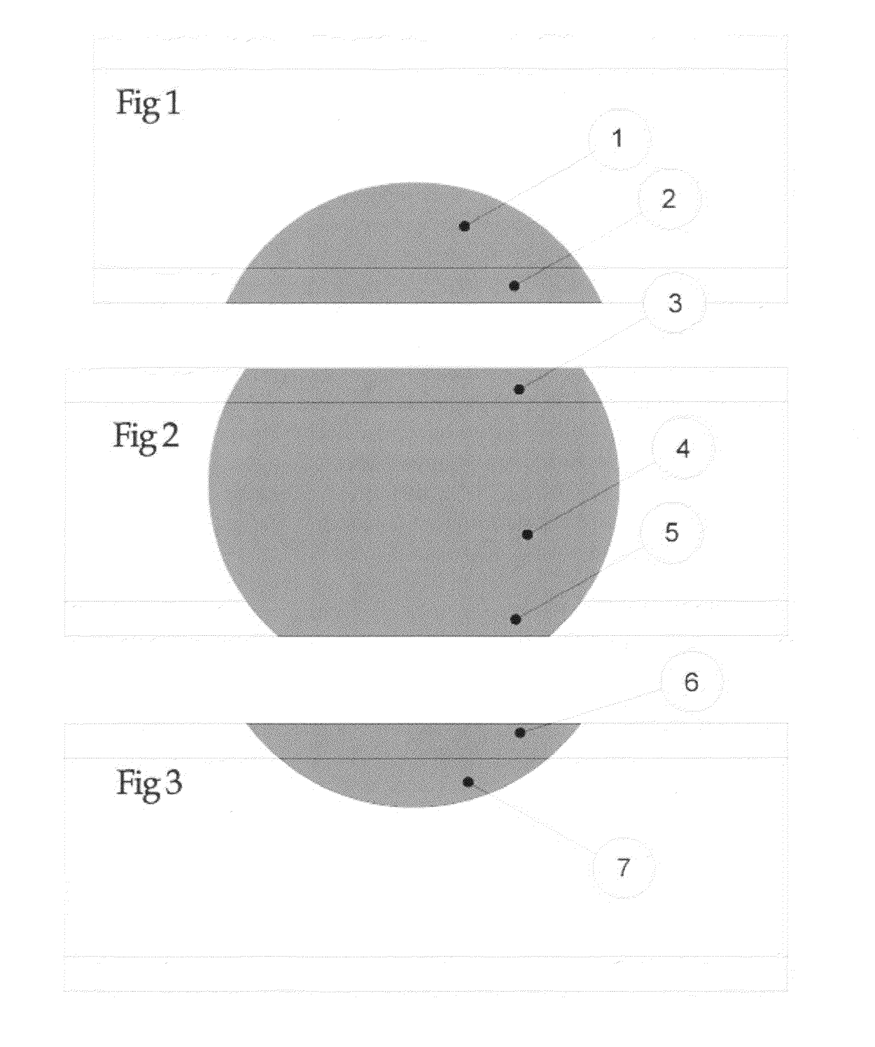

FIG. 1—Exterior View—Blinds Down

FIG. 2—Interior View—Blinds Down

FIG. 3—Exterior View—Blinds Up

### DETAILED DESCRIPTION OF THE INVENTION

Each figure represents a blind slat. FIG. 1 is the top slat; FIG. 2 is the slat underneath FIG. 1. And FIG. 3 is the slat under FIG. 2.

When blinds are closed, image can be seen clearly whether the louvers turn down or up.

All blinds overlap ⅛. What is visible of every slat except for the first one is 1⅞″ on 2″ blinds and ⅞″ on 1″ blinds. All blinds overlap ⅛ of an inch at the bottom of the upper blind slat (FIG. 2) and the top of the lower blind slat (FIG. 3). The bottom ⅛″ of the upper slat (FIG. 2) mirrors the top ⅛″ of the lower slat (FIG. 3)

In the case of the circle image, if we assemble with louvers to turn down. What is visible is FIGS. 1 & 2 (which is the top slat), (3 is covered by 2), 5, and 7. (6 is covered by 5).

Now in another instance, say the louvers are to turn up. What is visible in this scenario are 1, 3 (3 covers 2), 4, 6 (6 covers 5) and 7.

That's why It is important for the ⅛″ to mirror the next one in order to assemble with louvers to turn up or down and still get the same view and performance.

This process can be done on each side of the slat to show an image on both sides when blind is assembled and are closed.

I claim:

1. An adhesive image adapted for installing over vertical or horizontal louver blinds, each louver blind having a top, lateral sides, a bottom, a maximum width and a means for hanging the louver, said adhesive image comprising:
a front panel and a back adhesive panel, each panel having a top edge, a bottom edge, an inner side edge and an outer side edge, the front and back panels having length and width adapted to cover the louver with pressure sensitive adhesive on the back sides

2. An adhesive image as claimed in claim 1 wherein the louvered device is a verticle blind.

3. An adhesive image as claimed in claim 1 wherein the strips of flexible sheet material are made from resin or vinyl film coated on one side with pressure sensitive adhesive having a removable cover thereon

4. An adhesive image as claimed in claim 1 wherein the louvered device is a horizontal blind.

5. An adhesive image as claimed in claim 1 wherein the louvered device is a louvered window and the louvers are of a material which will permit the passage of light therethrough.

6. An adhesive image as claimed in claim 1 wherein each strip is the same width as the louver, when the louvered device is closed, the decorative design segment of each strip to cover both the visible portion of the louver and at least part of the hidden portion of the louver, thereby assuring a continuous pattern on the louvered device in case of minor variations in the overlap of the adjacent louvers.

7. An adhesive image as claimed in claim 1 wherein the entire set of elongated strips are mounted on a single removeable bottom cover sheet in the proper sequence and spatial relationship in which they are to be applied to the series of louvers on the louvered device.
